(19) United States
(12) Patent Application Publication
(10) Pub. No.: US 2019/0079350 A1
(43) Pub. Date: Mar. 14, 2019

(54) BACK PLATE, BACK PLATE ASSEMBLY, BACKLIGHT MODULE, AND DISPLAY MODULE

(71) Applicants: BOE TECHNOLOGY GROUP CO., LTD., Beijing (CN); BEIJING BOE DISPLAY TECHNOLOGY CO., LTD., Beijing (CN)

(72) Inventors: Ying Chen, Beijing (CN); Jinku Lv, Beijing (CN); Yutao Hao, Beijing (CN); Jian Li, Beijing (CN); Bochang Wang, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 15/770,643

(22) PCT Filed: Jul. 19, 2017
(86) PCT No.: PCT/CN2017/093514

§ 371 Date: Apr. 24, 2018

(30) Foreign Application Priority Data
May 2, 2017 (CN) 201710301249.X

(51) Int. Cl. G02F 1/1335; F21V 8/00; G02F 1/1333

(52) U.S. Cl. CPC G02F 1/133608; G02F 1/133308; G02B 6/0095

(57) ABSTRACT

A back plate for a backlight module. The back plate may comprise a bottom plate and side walls. The side walls may be substantially vertically connected to periphery of the bottom plate, thereby forming an accommodating cavity. The side walls may have a plurality of openings facing the accommodating cavity. A width of at least one of the plurality of the openings closer to the accommodating cavity may be smaller than a width thereof farther away from the accommodating cavity.

### CROSS-REFERENCE TO RELATED APPLICATIONS

This application claims the benefit of the filing date of Chinese Patent Application No. 201710301249.X filed on May 2, 2017, the disclosure of which is hereby incorporated by reference.

### TECHNICAL FIELD

This invention relates to a display technology, and more particularly, to a back plate, a back plate assembly, a backlight module, and a display module.

### BACKGROUND

Liquid crystal display (LCD) has been widely and massively used. With development of display technology, size of the display has also been greatly increased. However, it has been difficult to solve sheet wrinkle problem for ultra-large liquid crystal module. When the module is in an operational and lighting up mode, the sheet expands significantly after being heated. Because the size of the sheet is large and thermal expansion coefficient of the sheet is larger than that of the metal back plate, sheet wrinkle often appears as the expansion is hindered by the display panel. As shown in FIG. 7, a sheet 701 is wrinkled and forms a convex shape, thereby impacting picture quality. Although there is space reserved for sheet expansion in the display module, when the size of the sheet is too large, extension of the sheet toward surrounding reserved spaces cannot be achieved only by force from expansion of the sheet itself, and the extension is hindered by friction or some other factors.

### BRIEF SUMMARY

Accordingly, one example, of the present disclosure is a back plate. The back plate may comprise a bottom plate and side walls. The side walls may be substantially vertically connected to periphery of the bottom plate, thereby forming an accommodating cavity. The side walls may have a plurality of openings facing the accommodating cavity. A width of at least one of the plurality of openings closer to the accommodating cavity may be smaller than a width thereof farther away from the accommodating cavity. In one embodiment, the openings may be located on first surfaces of the side walls. In another embodiment, the openings may be between the first surfaces and second surfaces of the side walls. A cross-section of the opening parallel to the bottom plate may be a trapezoid. In one embodiment, the trapezoid may be an isosceles trapezoid. In another embodiment, a cross-section of the opening parallel to the bottom plate may have a shape having four sides, wherein two of the four sides are straight and parallel to each other, and the other two sides are curved. In another embodiment, the trapezoid may comprise two sub-trapezoids.

Another example of the present disclosure is a back plate assembly. The back plate assembly may comprise the buck plate according to one embodiment of the present disclosure. The back plate assembly may further comprise a hook in the opening. The hook may have a shape matching that of the opening, and a protrusion is provided on a surface of the hook away from the bottom plate. A cross-section of the hook parallel to the bottom plate may be a trapezoid, matching a cross section of the opening parallel to the bottom plate, and a bottom angle β of the trapezoidal cross-section of the hook may satisfy the following equation: ΔL=xLN×tan(β), wherein L is an average of lengths of top base and bottom base of the trapezoidal cross-section of the hook, x is an amount of temperature change, N is thermal expansion coefficient of the hook material, and ΔL is an amount of change in L when the amount of the temperature change is x.

A thickness of the hook may be less than a thickness of the opening in both a direction perpendicular to the side walls and a direction parallel to the side walls. The hook may be made of thermoplastic vulcanized rubber. Material of the hook may be configured to expand and squeeze toward a portion of the opening having a larger width as a temperature of the hook increases. The protrusion of the hook may be shifted farther away from the center of the bottom plate as a temperature of the hook increases.

Another example of the present disclosure is a backlight module. The backlight module may comprise a back plate assembly according to one embodiment of the present disclosure. The backlight module may further comprise a sheet. The sheet may include a rectangular body and extensions at periphery of the rectangular body. Each of the extensions may have a hole tor engaging the protrusion of the hook. Each of the extensions may have a rectangular shape. A length and a width of each of the extensions may be smaller than a length of the bottom base and a height of the trapezoidal cross-section of the opening parallel to the bottom plate respectively. A length and a width of the body may be smaller than those of the accommodating cavity respectively. A thermal expansion coefficient of material of the hook may be larger than that of the sheet. The backlight module may further comprise a light guiding plate between the bottom plate and the sheet.

Another example of the present disclosure is a display module. The display module may comprise a display panel and a backlight module according to one embodiment of the present disclosure.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention arc apparent from the following detailed description taken in conjunction with the accompanying drawings in which:

FIG. 1 is a schematic view of a back plate according to one embodiment of the present disclosure.

FIG. 2A is a schematic view of a hook at a contraction state and FIG. 2B is a schematic view of a hook at an expansion state after being heated in an opening according to one embodiment of the present disclosure.

FIG. 3A is a schematic cross-sectional view of an opening parallel to a bottom plate according to one embodiment of the present disclosure.

FIG. 3B is a schematic cross-sectional view of an opening parallel to the bottom plate according to one embodiment of the present disclosure.

FIG. 4 is a schematic cross-sectional view of an opening parallel to the bottom plate according to one embodiment of the present disclosure.

FIG. 5 is a schematic diagram of a back plate assembly according to one embodiment of the present disclosure.

FIG. 6 is a schematic diagram of a backlight module according to one embodiment of the present disclosure.

FIG. 7 is a schematic view of sheet wrinkle problem in prior art.

FIG. 8A is a cross-sectional view taken along line A-A of FIG. 1.

FIG. 8B is a cross-sectional view taken along line B-B of FIG. 1.

FIG. 9 is a schematic view of a relationship between a thickness of an opening and that of a hook according to one embodiment of the present disclosure.

### DETAILED DESCRIPTION

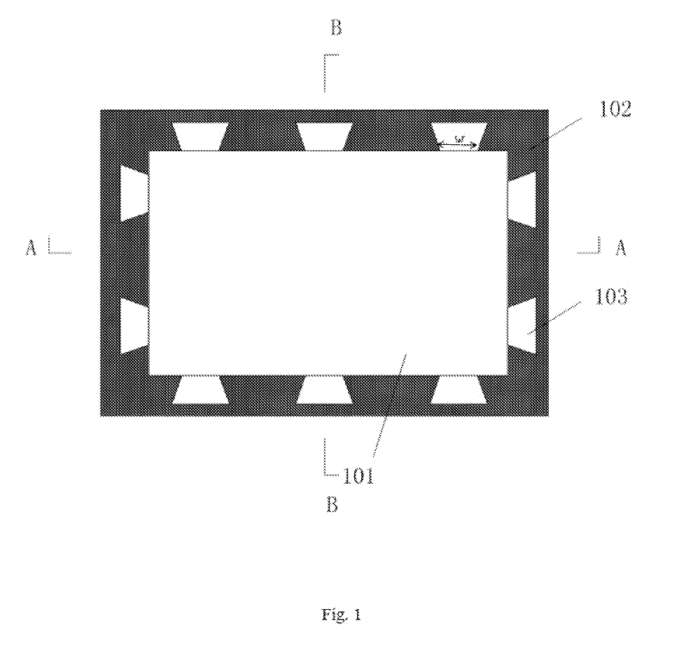

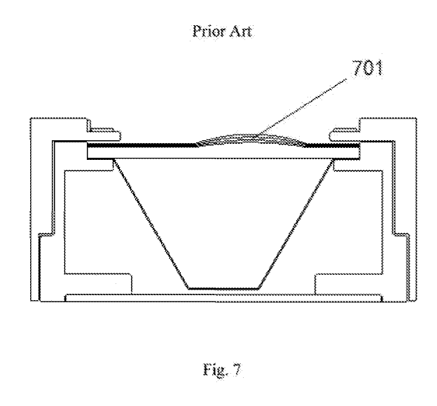

The present invention wilt be described in further detail with reference to the accompanying drawings and embodiments in order to provide a better understanding of the technical solutions of the present invention by those skilled in the art. Throughout the description of the invention, reference is made to FIGS. 1-9. When referring to the figures, like structures and elements shown throughout are indicated with like reference numerals.

FIG. 1 is a schematic view of a back plate according to one embodiment of the present disclosure. As shown in FIG. 1, the back plate includes a bottom plate 101 and side walls 102.

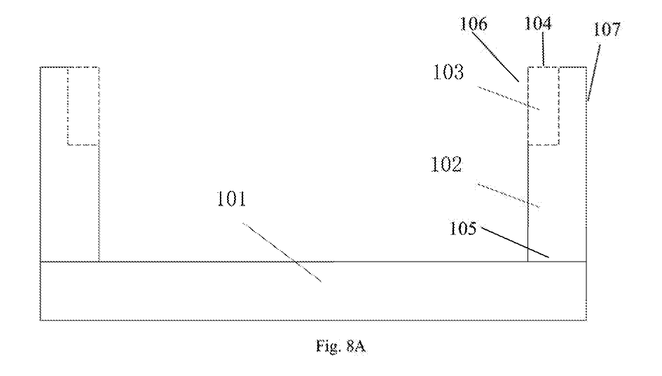

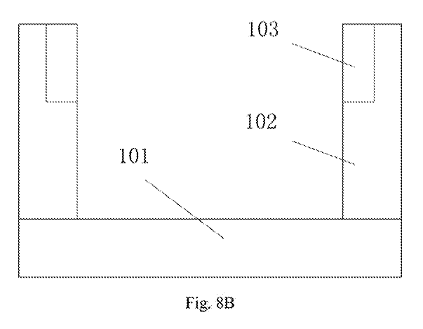

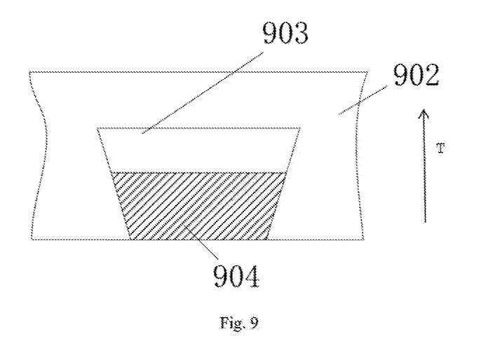

The side walls 102 are vertically connected to periphery of the bottom plate 101, forming an accommodating cavity for accommodating a light guiding plate. As shown in FIG. 8A, the side wall has four surfaces. A first surface 104 of a side wall refers to a surface of the side wall parallel to and farther away from the bottom plate. A second surface 105 of a side wall refers to a surface of the side wall parallel to and closer to the bottom plate. A third surface 106 of a side wall refers to a surface of the side wall perpendicular to the bottom plate and facing the accommodating cavity. A fourth surface 107 of a side wall refers to a surface of the side wall perpendicular to the bottom plate and away from the accommodating cavity.

A plurality of openings 103 facing the accommodating cavity are provided on the side walls 102. A width of the opening 103 closer to the accommodating cavity is smaller than a width of the opening 103 farther away from the accommodating cavity. Herein, a width of an opening in a side wall is measured in a cross-section of the opening parallel to the bottom plate along a direction parallel to the third surface of the side wall. A depth of an opening in a side wall is measured in a cross-section of the opening parallel to the bottom plate along a direction perpendicular to the third surface of the side wall. As shown in FIG. 8A, a thickness of an opening in a side wall is measured along a direction perpendicular to the bottom plate.

In one embodiment, the opening is used for accommodating a hook. The opening may be provided at the first surface of the side wall or the middle part of the side wall between the first surface and the second surface of the side wall. A height of the opening located in a side wall is determined based on a height of a sheet connected to the hook in the opening. In general, the sheet is located on a light exiting side of a light guiding plate. Thus, in one embodiment, the openings are located at the first surfaces of the sidewalls. The hooks in the openings are hooked to the sheet in a backlight module. When the backlight module is heated, the hooks and the sheet are expanded, and volumes thereof become larger.

In one embodiment of the present disclosure, the bottom plate has a substantially rectangular shape, as shown in FIG. 1.

FIG. 8A is a cross-sectional view along line A-A of FIG. 1. FIG. 8B is a cross-sectional view along line B-B of FIG. 1. As shown in FIG. 8A and FIG. 8B, in both the longitudinal direction and the width direction of the bottom plate 101, the side walls 102 are perpendicular 10 the bottom plate 101. Furthermore, a cross-section of the opening 103 in a plane perpendicular to the bottom plate in FIG. 1 is rectangular.

In one embodiment, the side walls are perpendicular to the bottom plate. That is, an angle between each of the side walls and the bottom plate is approximately 90°.

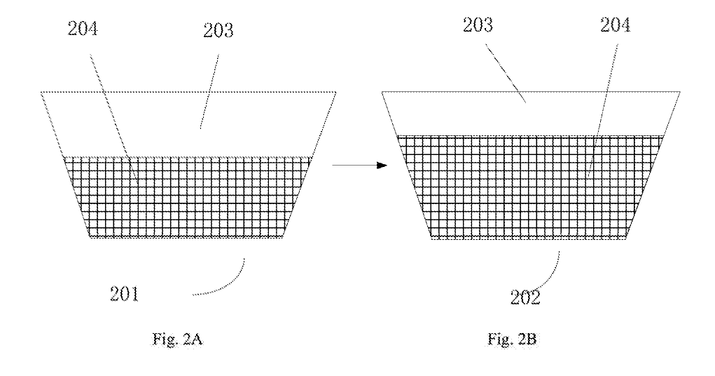

FIG. 2A is a schematic view of a hook at a contraction stale and FIG. 2B is a schematic view of a hook at an expansion state after being heated in an opening according to one embodiment of the present disclosure. As shown in FIG. 2, in operation, a hook 204 is provided in an opening 203. At the expansion state, material of the hook 204 is pushed to a portion of the opening 203 having a larger width. As such, the position of the hook 204 on a cross-section parallel lo the bottom plate is shifted toward a side of the opening 203 having a larger width. The hook 204 is changed from the contraction state 201 to the expansion state 202. That is, the hook 204 is shifted to a position farther away from the center of the bottom plate. As such, the sheet connected to the hook is stretched, thereby facilitating expansion of the sheet. As a result, sheet wrinkles, which would have been produced because of volume expansion of the sheet and inability of the sheet to freely expand, are prevented. In order to ensure that the stretching of the sheet is uniform, each of the side walls surrounding the bottom plate is provided with at least one opening. As such, the sheet can be stretched in all four directions when the hooks are shifted, thereby effectively improving flatness of the sheet in all directions. Furthermore, a problem of pulling the sheet by a force only at one direction, which would make the sheet deviating from a predetermined position, is avoided.

In one embodiment of the present disclosure, the opening is provided so that a width of the opening farther away from a center of the bottom plate is larger than that of the opening closer to the center of the bottom plate. As such, material of the hook after being heated and expanded is pushed toward a position where a width of the opening is larger, thereby changing a distance between the hook and the center of the bottom plate in a cross section parallel to the bottom plate. In practice, a shifting distance of the hook after being heated and expanded should be close to the extension distance of the sheet. In order to facilitate manufacturing and easy control of the shifting distance of the hook during the heating, the cross-section of the opening parallel to the bottom plate is set to be a trapezoidal shape. In one embodiment, the cross section is an isosceles trapezoid. As such, the hooks in the openings of the side walls along the longitudinal direction of the bottom plate extend along the width direction of the sheet. The hooks in the openings of the side walls along the width direction of the bottom plate extend along the length direction of the sheet.

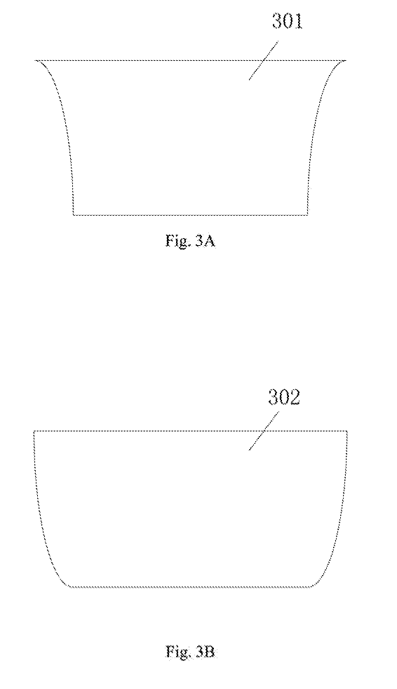

In some cases, the sheet material has different expansion coefficients at different temperatures. Furthermore, because original length and width of the sheet may be different, expansion of the length and the width of the sheet at different temperatures may be different even when the amount of the temperature change is the same. Thus, the shifting distance of the hook at different temperatures needs to be different. Accordingly, the cross-section of the opening parallel to the bottom plate may be set as a shape having four sides such as the openings 301 and 302 as shown in FIGS. 3A and 3B respectively. Two of the sides are straight and parallel to each other, and the other two sides are curved. As such, the changes of the distance between the hook and the center of the bottom plate arc different at different temperatures so that the hooks have different sensitivities to temperature change at different degrees of expansion.

In one embodiment, when a cross-section of the hook parallel to the bottom plate does not match a cross-section of the opening parallel to the bottom plate, it is still possible to realize a certain degree of shilling after the hook being heated and expanded. For example, the cross-section of the hook parallel to the bottom plate is a rectangle, but the cross-section of the opening parallel to the bottom plate is a trapezoid. Furthermore, a length of the rectangle equals to a length of a lop base of the trapezoid. As such, the hook is expanded in the width direction after being heated, and extended toward a portion of the opening having a larger width. Length of the hook is also increased.

When heated, dimensions of length, width, and thickness of the sheet are all expanded. Therefore, friction between the sheet and the plate directly contacting the sheet increases because the thickness of the sheet is increased after the sheet being heated. Thus, in order to reduce the increased friction, the cross-section of the opening parallel to the bottom plate may comprise two or more sub-trapezoids.

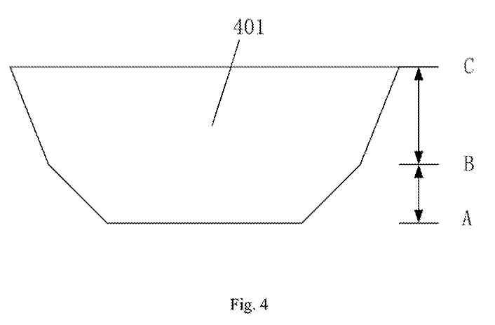

FIG. 4 is a schematic cross-sectional view of an opening parallel to the bottom plate according to one embodiment of the present disclosure. As shown in FIG. 4. the opening 401 has a trapezoidal cross-section at AB section with a bottom angle being a first angle. The opening 401 at BC section is also trapezoidal with a bottom angle being a second angle. The second angle is greater than the first angle. As such, when the hook is in the AB and BC sections respectively, the amount of change in the distance between the hook in the opening 401 and the center of the bottom plate has different sensitivity to temperature change.

In one embodiment, when the back plate is used together with a hook having a certain shape, the hook can expand and shift when heated. The portion of the hook connecting to the sheet is shifted toward a direction of the opening having a larger width, that is, shifted toward a direction farther away from the center of the bottom plate. As such, a pulling force away from the center of the bottom plate is provided to the sheet when temperature rises. This would prevent sheet wrinkles, which would have been produced due to volume expansion of the sheet and inability of the sheet to extend to surrounding reserved space due to friction between the sheet and the contacting light guiding plate. Furthermore, in one embodiment of the present disclosure, the cross-section of the opening parallel to the bottom plate is a trapezoid, which is easy to manufacture. Furthermore, it is easy to calculate the relationship between the shifting distance of the hook and the amount of the temperature change, which makes it convenient to maintain consistency of the dimensional change of the hook and the dimensional change of the sheet.

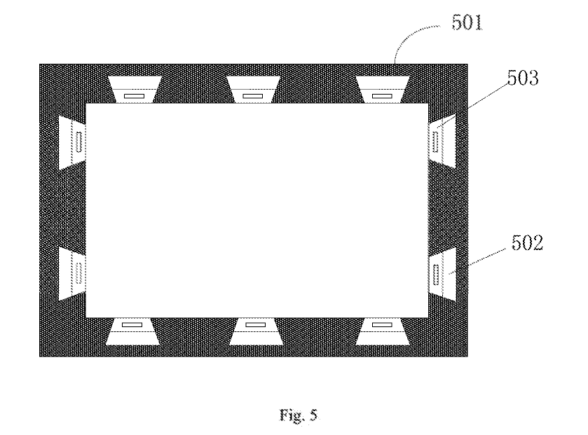

FIG. 5 shows a schematic diagram of a back plate assembly according to one embodiment of the present disclosure. As shown in FIG. 5, the back plate assembly comprises a back plate 501 and hooks 503 disposed in openings 502.

In one embodiment, the hook 503 is made of a material having an expansion coefficient greater than a predetermined value, such as plastic. The hook 503 is disposed in the opening 502 and the shape of the hook matches that of the opening 502. A protrusion 504 is provided on a side of the hook 503 farther away from the bottom plate. The backlight module generates heats when it is turned on. The hook 503 is heated and expanded. Under pressure from both sides of the opening 502 of the back plate 501, the hook 503 is squeezed toward a portion of the opening 502 having a larger width. Meanwhile, the sheet is pulled by the protrusion 504 of the hook, thereby preventing sheet wrinkles.

In embodiments of the present disclosure, the thermal expansion coefficient of the hook material may theoretically be any value. However, in order lo allow the hook to function as a pulling force when being heated, the shift distance of the hook may be greater than the change of the length or width of the sheet after being heated and expanded. If the thermal expansion coefficient of the hook material is too small, the shift distance of the hook in the opening may be less than the dimensional change of the sheet. Therefore, the thermal expansion coefficient of the hook material should be greater than a predetermined value.

In one embodiment, the protrusion 504 may have a rectangular shape, and hooked to a corresponding part of the sheet of the backlight module. A width of a cross-section of the opening parallel to the bottom plate farther away from the center of the bottom plate is larger than that closer to the center of the bottom plate. The hook expands when being heated, and the protrusion is shifted in a direction farther away from the center of the bottom plate. As a result, when the hook expands, the protrusion drives the sheet to extend in a direction away from the center of the bottom plate, thereby preventing wrinkles on the sheet.

In one embodiment, in order to ensure uniform stretching of the sheet, a hook is provided in at least one opening in each of the side walls surrounding the bottom plate. As such, the hooks can pull the sheet to extend toward the surrounding area when being shifted, thereby preventing wrinkles on the sheet, which would have been caused by die expansion of the sheet and simultaneously inability of the sheet to extend to the surrounding reserved space due to friction or other (actors. It is also ensured that the sheet docs not deviate from original position during the extension.

In one embodiment, in practice, the amount of the dimensional change of the hook caused by a certain amount of temperature change plays an important role in preventing wrinkles on the sheet of the backlight module. It is required that the sheet can be extended to the reserved space before wrinkling occurs. The dimensional change of the hook at a certain amount of temperature change can be controlled by controlling parameters such as shapes of the hook and the opening (such as width, thickness, angle, etc.). As such, the shift distance of the protrusion is controlled. In one embodiment, the cross-section of die hook parallel to the bottom plate is a trapezoid matching with the cross-section of the opening parallel to the bottom plate. A bottom angle β of the trapezoid may be calculated by the following equation:

ΔL=xLN×tan(β);

where L is an average of lengths of top base and bottom base of a trapezoidal cross-section of the hook, x is an amount of temperature change, N is thermal expansion coefficient of the hook material, and ΔL is an amount of change in L when the amount of the temperature change is x. For a specific product, ΔL is predetermined based on dimensional change of the sheet and degree of wrinkling when the amount of the temperature change is x. According to the predetermined ΔL, a predetermined bottom angle β of the trapezoid can be calculated. Since thermal expansion coefficient of most materials docs not change much at different temperature, N can usually be taken as a constant.

In one embodiment, in order to allow the surrounding hooks to pull the sheet when the temperature rises, it should be that ΔL>a·ΔL₁, a is greater than or equal to 0.5; ΔL₁ is a length change of the sheet when the amount of the temperature change is x. In one embodiment of the present disclosure, the relationship between the length change of the sheet and the thermal expansion coefficient of the sheet is: ΔL₁=L₁*Nⱼ, wherein L₁ is the sheet length, and N₁ is thermal expansion coefficient of the sheet. That is, xLN* tan(β)>L₁*N₁. Therefore, the thermal expansion coefficient N of the hook material may be determined comprehensively based on a feasible range of tan (β), L₁, N₁, L and potential amount of temperature change in actual operation. That is, a predetermined value of the thermal expansion coefficient N of the hook material is determined by the aforementioned parameters. At the same time, a depth of the opening cannot exceed a thickness of the side walls. ΔL is smaller than the thickness of the side walls. Based on the amount of the temperature range of a particular type of backlight module during use, a corresponding dimensional change of the sheet, thickness of the side wall, and other data, together with the above formula, a feasible range of thermal expansion coefficient of the hook material can be determined.

In one embodiment, in outer for the protrusion to shift when the hook expands, it is required that the book can be deformed when the hook is squeezed by side walls of the opening during expansion. Therefore, the material of the hook should have a certain degree of elasticity so that the hook can have elastic deformation or continuous plastic deformation during the squeezing. In one embodiment, the hook is made of thermoplastic vulcanized rubber (TPV). TPV has good elasticity and compression resistance, good environmental adaptability, strong anti-aging characteristics, a wide range of application temperature, and a wide range of softness and hardness available. Furthermore, TPV is easy to make and process. With high fluidity, TPV can be processed with injection, extrusion or other processing methods of thermoplastic polymers. Since TPV is easy to dye, it is easy to process it into a color that does not affect display effect of a display product. Furthermore, TPV has a high thermal expansion coefficient. An aluminum back plate in a backlight module generally has a thermal expansion coefficient of about 2.2 to 2.4*10⁻⁵ m/K. A sheet generally has a thermal expansion coefficient of about 4 to 6*10⁻⁵ m/K. TPV material has a thermal expansion coefficient of about 22.3*10⁻⁵ m/K. Thus, when a hook made of TPV is used and the backlight module is heated, the hook has sufficient sensitivity to the temperature change. As a result, the sheet can be stretched in time and prevented from generating wrinkles during thermal expansion.

In one embodiment, since the hook is expanded from a position closer to a center of the bottom plate to a position farther away from the center of the bottom plate during thermal expansion, a force pulling the sheet is generated by the expansion of the hook. Accordingly, a space needs to be reserved for the expansion of the hook so that the hook is allowed to extend in the reserved space upon heating to cause a change in the distance between the protrusion on the hook and the center of the bottom plate. Thus, in some embodiments as shown in FIG. 9, a thickness of the hook 904 in a thickness direction T of the side wall 902 does not exceed a depth of the opening 903. Furthermore, during the thermal expansion of the hook, in order to reduce influence of frictional force between the hook and the back plate or other contacting members, in a direction perpendicular to the bottom plate, a thickness of the hook is less than a thickness of the opening. This would prevent increasing of the contact friction between the hook and the opening, which would otherwise hinder expansion and shifting of the hook. The contact friction would be significantly increased if the thickness of the hook becomes larger than that of the opening after being heated and accordingly the hook is pressed from both the bottom and the top of the opening.

As can be seen from the above, the back plate assembly according to one embodiment of the present disclosure includes a back plate and hooks. Side walls of the back plate are provided with openings toward a center of the bottom plate of the back plate. The openings are located at the top or middle of the side walls. The opening is positioned at substantially the same height as the sheet connected to the hook in the opening. As such, when the sheet is thermally expanded, the hook expands and the protrusion of the hook connected to the sheet shifts. As a result, the sheet is pulled to extend toward surrounding reserved space, thereby preventing sheet wrinkles.

In addition, the hooks in the back plate assembly according to one embodiment of the present disclosure are hooked to the sheet through protrusions. As such, it is easy to assemble and/or disassemble the sheet from the hook. Furthermore, fastness of the connection between the hook and the sheet is ensured so that the connection between the sheet and the hook would not slip due to excessive frictional force between the sheet and components contacting the sheet.

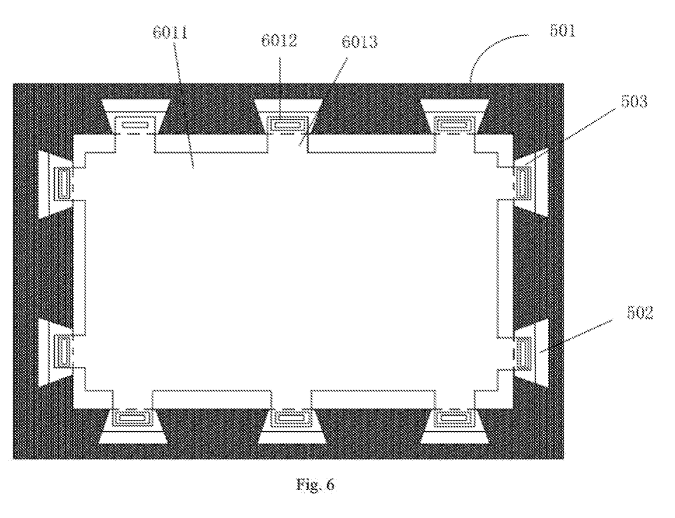

FIG. 6 shows a schematic diagram of a backlight module according to one embodiment of the present disclosure. As shown in FIG. 6. the backlight module includes a back plate assembly according to one embodiment of the present disclosure. The back plate assembly includes a back plate 501, openings 502 provided on side walls of the back plate 501, hooks 503 disposed in the openings 502, and a sheet. The sheet includes a rectangular sheet body 6011 and extensions 6012 provided at edges of the body 6011. The extension 6012 has a hole 6013 that engages with the protrusion on the hook. In the assembled state, the sheet is hooked to the protrusion of the hook through the hole 6013. As such, the hook and the sheet can be effectively connected, and it is easy to assemble. In addition, the hole is directly provided on the extension of the sheet body, which facilitates manufacturing process.

After the sheet is thermally expanded, the extension of the sheet also expands. The extension of the sheet extends in both longitudinal and width directions. If a length of the extension is equal to a length of the bottom base of the trapezoidal cross-section of the opening or a width of the extension is equal to a height of the trapezoidal cross-section of the opening, the opening would hinder shifting of the protrusion after the sheet is thermally expanded. Therefore, in order to avoid this phenomenon, in one embodiment, the length and width of the extension are smaller than the length of the bottom base and the height of the trapezoidal cross-section of the opening respectively.

In one embodiment of the present disclosure, the side walls and the bottom plate define an accommodating cavity that houses a light guiding plate of the backlight module in an assembled state. The sheet also needs to be assembled within the accommodating cavity. Thus, in some embodiments of the present disclosure, the length and the width of the sheet body are smaller than the length and the width of the accommodating cavity respectively. As such, the sheet has reserved space for heat expansion in the accommodating cavity.

In some embodiments of the present disclosure, the backlight module also includes a light guiding plate. The light guiding plate is provided in the accommodating cavity between the bottom plate and the sheet.

In a backlight module according to one embodiment of the present disclosure, openings are provided on the back plate. A width of the opening farther away from a center of the bottom plate of the back plate is greater than that closer to the center of the bottom plate of the back plate. As such, the hooks provided in the openings can be squeezed after being thermally expanded and shifted from a position of the opening having a narrower width to that having a wider width. Meanwhile, the protrusions on the hooks can also be moved from a position closer to the center of the bottom plate to a position fanner away from the center of the bottom plate. As such, the sheet is pulled by the protrusion. The problem that the sheet cannot extend because of friction between die sheet and the contacting components at two sides thereof is overcome. As a result sheet wrinkles due to thermal expansion arc avoided. Abnormality of exiting light from the backlight module caused by the wrinkles is also avoided.

In another embodiment of the present disclosure, a display module is provided The display module includes a display panel and a backlight module according to one embodiment of the present disclosure. In the display module, when temperature of the backlight module is increased, the extensions of the sheet are pulled so that the sheet can extend to surrounding reserved space. As such, sheet wrinkles are avoided. Such wrinkles could have otherwise been produced if it was difficult for the sheet in the backlight module lo expand to the reserved space. As a result, the sheet is kept flat, thereby preventing wrinkles from affecting exiting light of the backlight module. The display effect of the display module is accordingly not affected by the hearing of backlight module.

The embodiments of the present disclosure effectively solve the problem for large size or ultra-large size of LCD modules that the sheet cannot expand and extend freely due to the large frictional force caused by the large size of the LCD.

The descriptions of the various embodiments of the present invention have been presented for purposes of illustration, but are not intended to be exhaustive or limited to the embodiments disclosed. In the case of no conflict, the features in the embodiments and examples in the present application may be recombined with each other. Many modifications and variations will be apparent to those of ordinary skill in the an without departing from the scope and spirit of the described embodiments. The terminology used herein was chosen to best explain the principles of the embodiments, the practical application or technical improvement over technologies found in the marketplace, or to enable others of ordinary skill in the an to understand the embodiments disclosed herein.

1. A back plate comprising:
a bottom plate; and
side walls;
wherein the side walls are substantially vertically connected to periphery of the bottom plate, thereby forming an accommodating cavity,
the side walls having a plurality of openings facing the accommodating cavity, and
a width of at least one of the plurality of openings closer to the accommodating cavity is smaller than a width thereof farther away from the accommodating cavity.

2. The back plate according to claim 1, wherein the openings are located on first surfaces of the side walls.

3. The back plate according to claim 1, wherein the openings are between the first surfaces and second surfaces of the side walls.

4. The back plate according to claim 1, wherein a cross-section of the opening parallel to the bottom plate is a trapezoid.

5. The back plate according to claim 4, wherein the trapezoid is an isosceles trapezoid.

6. The back plate according to claim 1, wherein a cross-section of the opening parallel to the bottom plate has a shape having four sides, wherein two of the four sides are straight and parallel to each other, and the other two sides are curved.

7. The back plate according to claim 4, wherein the trapezoid comprises two sub-trapezoids.

8. A back plate assembly comprising the back plate according to claim 1, further comprising a hook in the opening;
wherein the hook has a shape matching that of the opening, and a protrusion is provided on a surface of the hook away from the bottom plate.

9. The back plate assembly according to claim 8, wherein a cross-section of the hook parallel to the bottom plate is a trapezoid, matching a cross section of the opening parallel to the bottom plate, and a bottom angle β of the trapezoidal cross-section of the hook satisfies the following equation: ΔL=×LN×tan(β),
wherein L is an average of lengths of top base and bottom base of the trapezoidal cross-section of the hook, x is an amount of temperature change, N is thermal expansion coefficient of the hook material, and ΔL is an amount of change in L when the amount of the temperature change is x.

10. The back plate assembly according to claim 8, wherein a thickness of the hook is less than a thickness of the opening in both a direction perpendicular to the side walls and a direction parallel to the side walls.

11. The back plate assembly according to claim 8, wherein the hook is made of thermoplastic vulcanized rubber.

12. The back plate assembly according to claim 8, wherein material of the hook is configured to expand and squeeze toward a portion of the opening having a larger width as a temperature of the hook increases.

13. The back plate assembly according to claim 8, wherein the protrusion of the hook is shifted farther away from the center of the bottom plate as a temperature of the hook increases.

14. A backlight module comprising:
a back plate assembly according to claim 8; and
a sheet;
wherein the sheet includes a rectangular body and extensions at periphery of the rectangular body, and each of the extensions has a hole for engaging the protrusion of the hook.

15. The backlight module according to claim 14, wherein each of the extensions has a rectangular shape, and a length and a width of each of the extensions are smaller than a length of the bottom base and a height of the trapezoidal cross-section of the opening parallel to the bottom plate respectively.

16. The backlight module according to claim 14, wherein a length and a width of the body are smaller than those of the accommodating cavity respectively.

17. The backlight module according to claim 14, wherein a thermal expansion coefficient of material of the hook is larger than that of the sheet.

18. The backlight module according to claim 14, further comprising a light guiding plate between the bottom plate and the sheet.

19. A display module comprising a display panel and the backlight module according to claim 14.
